(19) United States
(12) Patent Application Publication
(10) Pub. No.: US 2010/0005822 A1
(43) Pub. Date: Jan. 14, 2010

(54) VEHICLE WITH ELECTRIC AIR CONDITIONING AND SECONDARY COOLING CIRCUIT

(76) Inventors: Christopher Adam Bering, Dike, IA (US); Paul Thomas Bruss, Cedar Falls, IA (US)

Correspondence Address: DEERE & COMPANY, ONE JOHN DEERE PLACE, MOLINE, IL, 61265, US

(21) Appl. No.: 12/169,949

(22) Filed: Jul. 9, 2008

(51) Int. Cl. B60H 1/32

(52) U.S. Cl. 62/239

(57) ABSTRACT

An air conditioning system for a vehicle includes an auxiliary compartment, and a secondary cooling circuit positioned within the auxiliary compartment. The secondary cooling circuit includes a radiator and an electric coolant pump assembly. An AC circuit includes an electric compressor assembly, a condenser, an evaporator, and an electric fan for blowing air through the evaporator. The compressor assembly and the condenser are each located within the auxiliary compartment. The condenser is configured as a refrigerant to coolant heat exchanger with a refrigerant flow path and a coolant flow path. The refrigerant flow path is in fluid communication with each of the compressor assembly and the evaporator, and the coolant flow path is in fluid communication with each of the coolant pump assembly and the radiator. The AC circuit and the secondary cooling circuit may be mounted to a common sub-frame which is removably attached to a cab of the vehicle.

### FIELD OF THE INVENTION

The present invention relates to vehicles, and, more particularly, to air conditioning systems for vehicles.

### BACKGROUND OF THE INVENTION

Vehicles such as passenger automobiles commonly include an air conditioning (AC) system which is used to provide cooled air to the passengers within a passenger compartment. The AC system typically includes a compressor, a condenser, an evaporator and a blower. The power unit in such a vehicle is usually in the form of an internal combustion (IC) engine, usually spark ignition or diesel, which also mechanically drives the compressor of the AC system. When driven by the IC engine, the compressor is located in the engine compartment in relatively close proximity to the IC engine.

It is also common to utilize an AC system in a work machine to provide cooled air to an interior of an operator's cab. Work machines such as agricultural, forestry, construction and industrial work machines, typically use diesel engines with better torque, lugging and pull-down characteristics for work operations. The compressor for the AC system is again typically mechanically driven by the diesel engine, and thus located within the engine compartment. Since the cab is separate from the engine compartment, the compressor is fluidly connected by suitable rigid or flexible fluid lines to the other components of the AC system mounted to the cab. In the event that it is necessary to remove the cab, such as for repair or maintenance purposes, the refrigerant within the AC system is removed, and then the fluid lines are disconnected between the compressor and cab mounted AC system components. This is time consuming and expensive, and has the potential for loss of refrigerant to the atmosphere.

Diesel engines are subject to increasingly stringent emissions standards within the United States of America (USA) and the European Union (EU). In an effort to comply with these emissions standards, devices such as particulate filters, catalytic reduction systems, etc. are co-located with the engine in the engine compartment, usually mounted to the engine. Space within the engine compartment is thus at a premium.

It is known to drive an AC compressor with an electric motor for both automobile and work machine applications. In the case of an automobile, the compressor is still located in the engine compartment where there is more room, and the evaporator is located in a duct leading to the passenger compartment. In the case of a work machine, reference is made to related U.S. Pat. Nos. 5,408,843 and 5,520,015, each of which disclose an AC system which is fluidly connected to a charge air cooler located in the engine compartment. The AC system is therefore not isolated from the engine compartment and it is necessary to drain and disconnect the fluid lines in order to remove the operator's cab.

What is needed in the art is an AC system for a vehicle which is not directly mechanically coupled with the IC engine, and does not occupy space within the engine compartment.

### SUMMARY OF THE INVENTION

The invention in one form is directed to a vehicle including an engine compartment, an operator's cab, and an AC circuit mounted on the cab for providing cool air within the cab. The AC circuit includes a compressor, a first electric motor for driving the compressor, a condenser, and an evaporator.

The invention in another form is directed to a vehicle including an operator's cab, a compartment mounted to the cab, and an AC circuit. The AC circuit includes a compressor, a first electric motor for driving the compressor, a condenser, and an evaporator. Each of the compressor, the first electric motor and the condenser are located within the compartment. The evaporator is located adjacent to an interior of the cab.

The invention in yet another form is directed to an AC system for a vehicle having an engine compartment. The AC system includes an auxiliary compartment, and a secondary cooling circuit positioned within the auxiliary compartment. The secondary cooling circuit includes a radiator and an electric coolant pump assembly. An AC circuit includes an electric compressor assembly, a condenser, an evaporator, and an electric fan for blowing air through the evaporator. The compressor assembly and the condenser are each located within the auxiliary compartment. The condenser is configured as a refrigerant to coolant heat exchanger with a refrigerant flow path and a coolant flow path. The refrigerant flow path is in fluid communication with each of the compressor assembly and the evaporator, and the coolant flow path is in fluid communication with each of the coolant pump assembly and the radiator.

In a further form of the invention, the AC circuit and the secondary cooling circuit are each mounted to a common sub-frame which is removably attached to the cab.

### BRIEF DESCRIPTION OF THE DRAWINGS

FIG. 1 is a schematic, side view of a vehicle including an embodiment of an AC system of the present invention;

FIG. 2 is a fragmentary, partially exposed, side view of the vehicle shown in FIG. 1, illustrating placement of the AC system at the rear of the cab;

FIG. 3 is a schematic illustration of the AC system shown in FIGS. 1 and 2;

FIG. 4 is a plan view of the AC system shown in FIGS. 1-3, mounted to a common sub-frame; and

FIG. 5 is a rear perspective view of the cab shown in FIGS. 1 and 2, illustrating the cover for the electronics compartment housing the AC system, with the exposed electric fans.

### DETAILED DESCRIPTION OF THE INVENTION

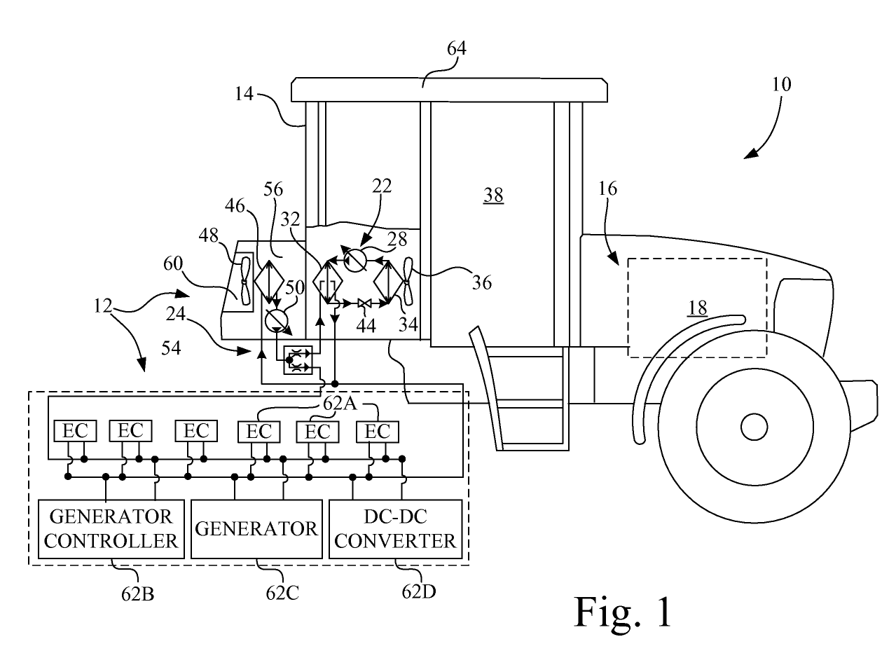

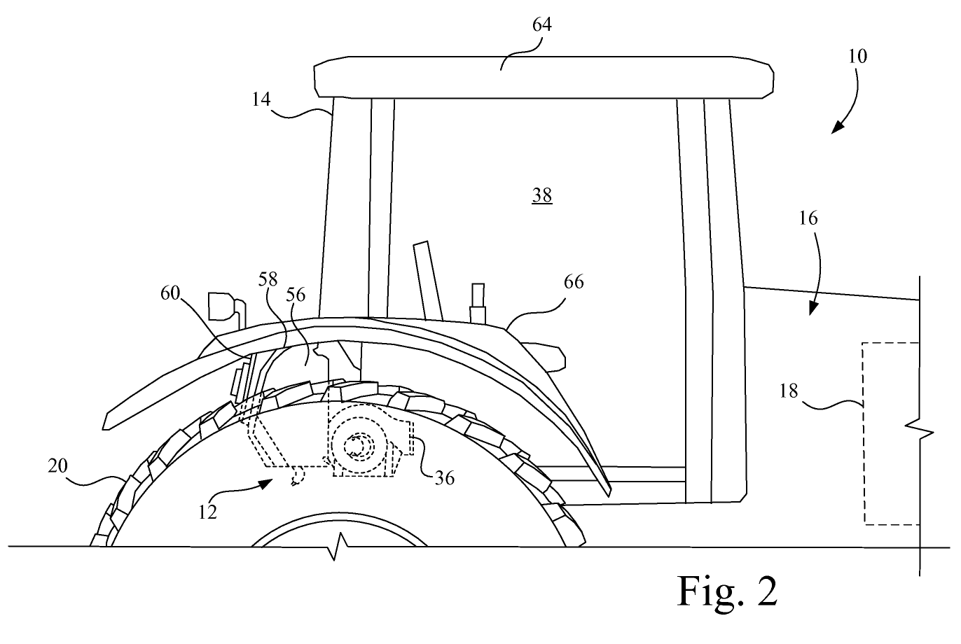

Referring now to the drawings, and more particularly to FIGS. 1 and 2, there is shown a vehicle 10 including an embodiment of an AC system 12 of the present invention. Vehicle 10 is shown as a work machine in the form of an agricultural tractor, but could be a different type of vehicle such as a forestry work machine, construction work machine, industrial work machine, passenger automobile, etc.

Tractor 10 generally includes a chassis (not specifically numbered) to which are mounted a cab 14, engine compartment 16 housing an engine 18, and rear drive wheels 20. The exact configuration of the general make-up of tractor 10 (or other vehicle) is not critical to the present invention. For example, tractor 10 could be propelled by tracks rather than by rear drive wheels.

With conventional AC systems as described above, the various components of the AC system are disposed in and traverse between both the engine compartment and the cab. For purposes of description herein, the enclosed area occupied by an operator or passenger will be referred to as a “cab”, although any designation such as passenger compartment, etc. could equally be used.

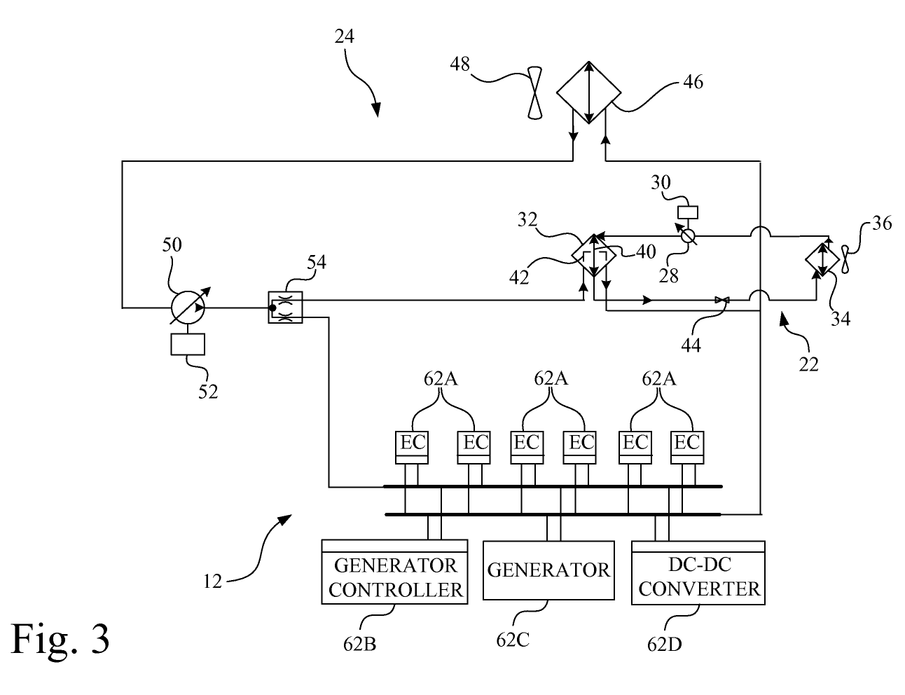

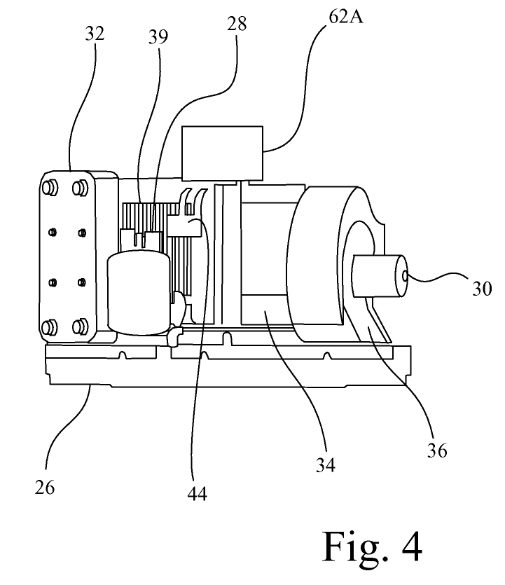

In contrast with conventional AC systems, the AC system of the present invention includes components which are exclusively mounted to and carried by the cab 14. Referring to FIGS. 1 and 3, conjunctively, AC system 12 generally includes an AC circuit 22 and a secondary cooling circuit 24, each of which are mounted to cab 14. In one embodiment, AC circuit 22 and secondary cooling circuit 24 are each mounted to a common sub-frame 26 (FIG. 4), which in turn is removably mounted to cab 14 at a desired location. This allows the entire AC system 12 to be removed from cab 14 and sent in to the manufacturer for service or repair.

AC circuit 22 is mounted on cab 14 and provides cool air within cab 14. AC circuit 22 includes a compressor 28, a first electric motor 30, a condenser 32, an evaporator 34, and a fan 36. First electric motor 30 drives compressor 28, and could be configured as a direct current (DC) motor or as an alternating current (AC) motor. Of course, a suitable converter or inverter could be used, if necessary, depending on the source of the electrical power. For example, the electrical power can be obtained from a motor driven generator, a bank of batteries, etc. Compressor 28 is fluidly coupled between an outlet from evaporator 34 and an inlet to condenser 32.

Evaporator 34 is preferably positioned adjacent an interior 38 of cab 14, such as within or at the discharge end of a duct leading to cab interior 38. In the illustrated embodiment, evaporator 34 is generally positioned behind the seat of the operator and fan 36 blows cooled air through a duct to exit at or near a floor within cab interior 38. Fan 36 is shown as a squirrel cage blower, but could be differently configured. Fan 36 and evaporator 34 can also be serially arranged with a heater 39 (FIG. 4) for selectively blowing heated or cooled air into cab interior 38. The general operation of evaporator 34 and fan 36 are known, and not described in further detail herein.

Condenser 32 is configured as a refrigerant to coolant heat exchanger with a refrigerant flow path 40 and a separate coolant flow path 42. The refrigerant flow path 40 is in fluid communication with each of compressor 28 and evaporator 34. An expansion valve 44 of known design is fluidly interconnected between the outlet side of refrigerant flow path 40 from condenser 32 and the inlet to evaporator 34. The coolant flow path 42 is in fluid communication with secondary cooling circuit 24, described in more detail below.

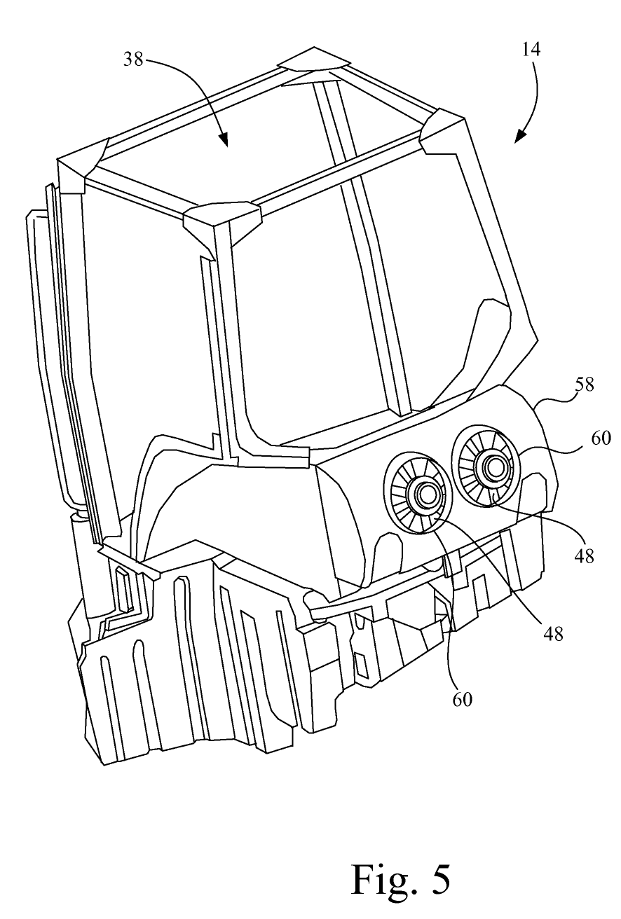

Secondary cooling circuit 24 is mounted on cab 14, and generally includes a radiator 46, a radiator fan 48, a coolant pump 50, a second electric motor 52, and a flow divider 54. Secondary cooling circuit 24 is termed “secondary” in that heat is transferred from AC circuit 22 and electronic components 62A-62D to secondary cooling circuit 24, and then to ambient. Secondary cooling circuit 24 is also a low temperature cooling circuit when compared with the temperature of the coolant within the cooling circuit associated with IC engine 18. In the embodiment shown, secondary cooling circuit 24 is a liquid cooling circuit (e.g., water and glycol mixture) which is positioned within an auxiliary compartment in the form of an electronics compartment 56 used to house other onboard electronic components (FIGS. 1, 2 and 5). A rear cover 58 is attached to the back wall of cab 14. Rear cover 58 includes one or more exhaust openings 60 which are each associated with a respective fan 48. In the embodiment shown, a pair of fans 48 are positioned between exhaust openings 60 and radiator 46, and fans 48 thus draw air through radiator 46. However, it is possible to use only a single fan 48, or place the fan on the inlet side of radiator 46 to push the air though radiator 46 prior to exhausting to the ambient. Air is drawn in through screened openings at the top and bottom of rear cover 58 (not specifically shown) and exhausted through exhaust openings 60.

The remaining components of secondary cooling circuit 24 are also mounted within electronics compartment 56; namely, coolant pump 50, second electric motor 52, and flow divider 54. Second electric motor 52 is an AC or DC motor, as appropriate, which drives pump 50 at a desired flow rate, which can be either fixed or variable.

For a tractor 10 as shown, it is common for other electronic components to also be mounted within electronics compartment 56. The electronic components 62 can include, e.g., a number of fan and pump controllers 62A, a generator controller 62B, a generator 62C, a DC-to-DC converter 62D, a vehicle control unit (VCU, not shown), a transmission control unit (TCU, not shown), etc. In the illustrated embodiment of AC system 12, each of electronic components 62A-62D are water cooled electronic components which are in fluid communication with secondary cooling circuit 24. To that end, flow divider 54 splits the flow from the output of pump 50 such that part of the flow is used for cooling within condenser 32, and the remaining part of the flow is used for cooling electronic components 62A-62D. Flow divider 54 includes an inlet in fluid communication with the outlet from radiator 46 (via pump 50), a first outlet in fluid communication with condenser 32, and a second outlet in fluid communication with liquid cooled electronic components 62A-62D. The electronic components 62A-62D are connected in parallel with the second outlet from flow divider 54 and with the inlet to radiator 46. Flow divider 54 is assumed to evenly split the flow in the illustrated embodiment, but it will be appreciated that the flow can also be unevenly split depending on the application.

In the illustrated embodiment, all of electronic components 62A-62D are water cooled components. It will be appreciated, however, that it may not be necessary to water cool all of the electronic components, or only a portion of the electronic components. Moreover, in the illustrated embodiment, most of the components of AC system 12 are “skid mounted” to common sub-frame 26, and installed or removed as a unit within electronics compartment 56. For other applications, it may be desirable and/or necessary to mount some or all of the components of AC system 12 within another compartment or area within cab 14, such as in the roof compartment 64 and/or console 66. If components of AC system 12 are split between electronics compartment 56, roof compartment 64 and/or console 66, then suitable fluid, electric and/or data lines can be used to interconnect the components.

During operation, AC circuit 22 provides cooled air within cab interior 38. Secondary cooling circuit 24 concurrently cools the refrigerant within condenser 32 and the electronic components 62A-62D. All pumps, fans, blowers, etc. using rotational input power are powered by electric motors so that no interconnections are required between AC system 12 and the engine compartment 16.

The AC system 12 of the present invention allows the cab to be more easily removed from the chassis without draining refrigerant, or disconnecting fluid and/or electric lines associated with the AC system, etc. The AC system may be assembled as a unit and tested at the factory, which reduces assembly errors and chances for refrigerant leakage. Moving the components of the AC system to the cab also frees up space within the engine compartment, which is becoming more important with ever increasing emissions requirements and associated hardware. The secondary cooling circuit effectively cools the components of AC circuit 22 for longer life of the individual components, as well as providing cooler air to the cab interior 38.

Having described the preferred embodiment, it will become apparent that various modifications can be made without departing from the scope of the invention as defined in the accompanying claims.

1. A vehicle, comprising:
an engine compartment;
an operator's cab;
an air conditioning (AC) circuit mounted on said cab for providing cool air within said cab, said AC circuit including a compressor, a first electric motor for driving said compressor, a condenser, and an evaporator.

2. The vehicle of claim 1, including a secondary cooling circuit mounted on said cab, said secondary cooling circuit including a radiator, a coolant pump, and a second electric motor for driving said pump; and
wherein said condenser is configured as a refrigerant to coolant heat exchanger with a refrigerant flow path and a coolant flow path, said refrigerant flow path being in fluid communication with each of said compressor and said evaporator, said coolant flow path being in fluid communication with each of said pump and said radiator.

3. The vehicle of claim 2, wherein said AC circuit and said secondary cooling circuit are mounted to a common sub-frame which is removably attached to said cab.

4. The vehicle of claim 2, wherein said coolant pump is fluidly connected between said radiator and said condenser.

5. The vehicle of claim 2, including an electronics compartment located at a rear wall of said cab, said electronics compartment including a cover with an exhaust opening positioned in association with said radiator, said secondary cooling circuit including an electric radiator fan for blowing air through said radiator and said exhaust opening.

6. The vehicle of claim 5, including a plurality of electronic components positioned within said electronics compartment, at least one said electronic component being a liquid cooled electronic component which is in fluid communication with said secondary cooling circuit.

7. The vehicle of claim 6, including a flow divider with an inlet, a first outlet and a parallel connected second outlet, said inlet being in fluid communication with an outlet from said radiator, said first outlet be in fluid communication with said condenser, and said second outlet being in fluid communication with said at least one liquid cooled electronic component.

8. The vehicle of claim 6, wherein said at least one liquid cooled electronic component comprises a plurality of liquid cooled electronic components which are fluidly connected in parallel with said secondary cooling circuit.

9. The vehicle of claim 1, wherein said evaporator is positioned adjacent an interior of said cab, and including an electric fan positioned adjacent said evaporator for blowing cooled air into said cab.

10. The vehicle of claim 1, wherein said compressor is fluidly coupled between an outlet from said evaporator and an inlet to said condenser.

11. The vehicle of claim 1, wherein said vehicle is one of an agricultural work machine, a construction work machine, a forestry work machine, and an industrial work machine.

12. A vehicle, comprising:
an operator's cab;
a compartment mounted to said cab; and
an air conditioning (AC) circuit including a compressor, a first electric motor for driving said compressor, a condenser, and an evaporator, each of said compressor, said first electric motor and said condenser being located within said compartment, said evaporator being located adjacent an interior of said cab.

13. The vehicle of claim 12, wherein said compartment is one of an electronics compartment, a roof compartment, and a console.

14. The vehicle of claim 12, wherein said evaporator is also located within said compartment.

15. The vehicle of claim 12, including a secondary cooling circuit mounted on said cab, said secondary cooling circuit including a radiator, a coolant pump, and a second electric motor for driving said pump; and
wherein said condenser is configured as a refrigerant to coolant heat exchanger with a refrigerant flow path and a coolant flow path, said refrigerant flow path being in fluid communication with each of said compressor and said evaporator, said coolant flow path being in fluid communication with each of said pump and said radiator.

16. The vehicle of claim 15, wherein said AC circuit and said secondary cooling circuit are mounted to a common sub-frame which is removably attached to said cab.

17. The vehicle of claim 15, including an electronics compartment located at a rear wall of said cab, said electronics compartment including a cover with an exhaust opening positioned in association with said radiator, said secondary cooling circuit including an electric radiator fan for blowing air through said radiator and said exhaust opening.

18. The vehicle of claim 17, including a plurality of electronic components positioned within said electronics compartment, at least one said electronic component being a liquid cooled electronic component which is in fluid communication with said secondary cooling circuit.

19. The vehicle of claim 18, including a flow divider with an inlet, a first outlet and a parallel connected second outlet, said inlet being in fluid communication with an outlet from said radiator, said first outlet be in fluid communication with said condenser, and said second outlet being in fluid communication with said at least one liquid cooled electronic component.

20. The vehicle of claim 18, wherein said at least one liquid cooled electronic component comprises a plurality of liquid cooled electronic components which are fluidly connected in parallel with said secondary cooling circuit.

21. An air conditioning system for a vehicle having an engine compartment, said air conditioning system comprising:
an auxiliary compartment;
a secondary cooling circuit positioned within said auxiliary compartment, said secondary cooling circuit including a radiator and an electric coolant pump assembly; and
an air conditioning (AC) circuit including an electric compressor assembly, a condenser, an evaporator, and an electric fan for blowing air through said evaporator, each of said compressor assembly and said condenser being located within said auxiliary compartment, said condenser being configured as a refrigerant to coolant heat exchanger with a refrigerant flow path and a coolant flow path, said refrigerant flow path being in fluid communication with each of said compressor assembly and said evaporator, said coolant flow path being in fluid communication with each of said coolant pump assembly and said radiator.

22. The vehicle of claim 21, including a secondary cooling circuit mounted on said cab, said secondary cooling circuit including a radiator, a coolant pump, and a second electric motor for driving said pump; and
wherein said condenser is configured as a refrigerant to coolant heat exchanger with a refrigerant flow path and a coolant flow path, said refrigerant flow path being in fluid communication with each of said compressor and said evaporator, said coolant flow path being in fluid communication with each of said pump and said radiator.

23. The vehicle of claim 21, wherein said AC circuit and said secondary cooling circuit are mounted to a common sub-frame which is removably attached to said cab.

24. The vehicle of claim 23, including at least one electronic component which is a liquid cooled electronic component in fluid communication with said secondary cooling circuit.

25. The vehicle of claim 24, including a flow divider with an inlet, a first outlet and a parallel connected second outlet, said inlet being in fluid communication with an outlet from said radiator, said first outlet be in fluid communication with said condenser, and said second outlet being in fluid communication with said at least one liquid cooled electronic component.

26. The vehicle of claim 25, wherein said at least one liquid cooled electronic component comprises a plurality of liquid cooled electronic components which are fluidly connected in parallel with said secondary cooling circuit.
